(19) United States
(12) Patent Application Publication
(10) Pub. No.: US 2014/0175812 A1
(43) Pub. Date: Jun. 26, 2014

(54) LOCKING SYSTEM COMPONENT

(71) Applicant: Brose Schliesssysteme GmbH & Co. KG, Wuppertal (DE)

(72) Inventors: Rainer Wirths, Wuppertal (DE); Roman Joschko, Dormagen (DE)

(21) Appl. No.: 14/137,486

(22) Filed: Dec. 20, 2013

(30) Foreign Application Priority Data
Dec. 23, 2012 (DE) 10 2012 025 172.6

(51) Int. Cl. E05B 77/02

(52) U.S. Cl. CPC E05B 77/02
USPC 292/194

(57) ABSTRACT

The invention relates to a locking system component for a locking system which is assigned to a closure element of a motor vehicle, wherein an impact arrangement for absorbing momentum of a movement element is provided. It is proposed that the impact arrangement has a plastics foam element which consists at least partially, and in some embodiments completely, of a microcellular, open-cell plastics foam, in particular of a polyurethane foam.

### CLAIM OF PRIORITY

This application claims the benefit of German Patent Application No. DE 10 2012 025 172.6, filed Dec. 23, 2012, the disclosure of which is incorporated by reference herein in its entirety.

### FIELD OF THE INVENTION

The invention relates to a locking system component for a locking system and to a locking system.

### BACKGROUND

The locking system in question is assigned to a closure element of a motor vehicle and provides various functions which are associated with fixing the closure element in its locked position. The expression “closure element” should be understood broadly in the present case. It includes doors, in particular side doors, flaps, in particular tailgates, boot lids, engine bonnets, luggage compartment spaces or the like.

A locking system of the above type may comprise a large number of different locking system components. These include a motor vehicle lock which interacts regularly with a lock striker or the like, or an auxiliary locking arrangement which serves to adjust the closure element from a pre-locking position into a main locking position.

The known locking system component (DE 20 2008 007 719 U1), on which the invention is based, is configured as a motor vehicle lock. The motor vehicle lock is equipped with a number of motor-driven comfort functions which are based in each case on adjustment of actuators, more generally of movement elements. An example of such a comfort function is the motor-driven lifting out of the pawl of the motor vehicle lock in order to open the closure element.

In order in particular to keep the design of the known motor vehicle lock simple in terms of control, provision is made there for the motor-driven adjustment to take place in the blocking mode. This means that the relevant movement element is moved by a motor against an impact arrangement which absorbs the momentum of the movement element. The impact arrangement is configured here as a rubber buffer which initially reacts by elastic deformation when struck by the movement element. In this way, the mechanical load on the components located behind the rubber buffer can be effectively reduced.

However, a disadvantage with the use of the above rubber buffer as impact arrangement is the fact that such a rubber buffer acts as an elastic spring, resulting in corresponding springback. The springback can result in the movement element being wrongly positioned once it has been moved into the impact arrangement. Furthermore, the springback can cause a kind of bouncing which can cause undesired noise effects.

The same is the case for a known locking system component configured as an auxiliary locking arrangement (DE 20 2008 007 719 U1).

The invention is based on the problem of configuring and developing the known locking system component in such a way that the operating behaviour of the impact arrangement is improved.

### SUMMARY

It is proposed that the impact arrangement has a plastics foam element which consists at least partially, (or in an embodiment completely), of a microcellular, open-cell plastics foam, in particular of a polyurethane foam. According to the proposal, it has been found that with such a plastics foam not only can the mechanical loading of the components involved be reduced when the movement component strikes the impact arrangement, but that the open-cell plastics foam can have exceptionally good damping properties, given a suitable design. As a result, the movement energy of the movement element can be dissipated to a considerable extent within the plastics foam. Bouncing back of the movement element after striking the impact element can thus be avoided in an elegant manner. After striking and the associated deformation of the plastics foam, the plastics foam relaxes relatively slowly, depending on the design, back into its starting constellation.

The solution according to the proposal is particularly suitable for a locking system component configured as a motor vehicle lock and for a locking system component configured as an auxiliary locking arrangement. This is because the motor-driven comfort functions of these components are triggered only on demand, rather than continuously. The above, relatively slow relaxation of the plastics foam can be readily accepted in these embodiments.

Some embodiments can relate to advantageous design variants for the plastics foam. In an embodiment, the use of the material PORON® has been found to be exceptionally advantageous. The material PORON® originates from the Rogers Corporation, Connecticut, USA. Very particularly good damping results can be achieved with the PORON® material. At the same time, only little material fatigue has been found in the case of the use according to the proposal as material for an impact arrangement as above.

It has furthermore been found in tests that the microcellular, open-cell plastics foam can be configured in an exceptionally thin manner in the momentum direction for the applications in question without appreciatively losing its damping properties.

An embodiment provides that the inherent elasticity of the plastics foam is used for fastening the plastics foam element. What is interesting is that this is possible with the solution according to the proposal, given a suitable design, without the damping properties of the plastics foam being affected excessively.

According to an embodiment, a locking system which is assigned to a closure element of a motor vehicle is claimed as such. The locking system is equipped here with a motor vehicle lock according to the proposal and/or with an auxiliary locking arrangement according to the proposal. To this extent, reference may be made to all of the embodiments of the motor vehicle lock and auxiliary locking arrangement.

In an embodiment, the invention provides a locking system component for a locking system which is assigned to a closure element of a motor vehicle, wherein an impact arrangement for absorbing momentum of a movement element is provided, wherein the impact arrangement has a plastics foam element which consists at least partially, (and in an embodiment completely) of a microcellular, open-cell plastics foam, such as a polyurethane foam.

In an embodiment, the locking system component is configured as a motor vehicle lock.

In an embodiment, the locking system component is configured as an auxiliary locking arrangement, by way of which adjustment of the closure element from a pre-locking position into a main locking position is able to be brought about.

In an embodiment, the plastics foam element of the impact arrangement can be brought into direct engagement with the movement element when the momentum is absorbed, or in that the impact arrangement provides a separate contact surface between the plastics foam element and the movement element, said separate contact surface being able to be brought into direct engagement with the movement element when the momentum is absorbed and directing the momentum onto the plastics foam element.

In an embodiment, the plastics foam element material is configured as PORON® material.

In an embodiment, the cell size of the cells of the plastics foam element material is between about 3 μm and about 500 μm, such as between about 10 μm and about 70 μm. In an embodiment the cell zie of the cells of the plastics foam element material is about 40 μm.

In an embodiment, the density of the plastics foam element material, measured according to ASTDM D 3574-95 Test A, is in a range between about 200 kg/m³ and 440 kg/m³.

In an embodiment, the hardness (Shore “O”), measured by durometer according to ASTM D 2240-97, is between about 1.5 and about 70, such as between about 1.5 and about 4, such as about 2.

In an embodiment, the recovery, measured using a resiliometer according to ASTM D 2632 (vertical rebound), is between about 3% and about 9%, such as between about 4% and about 8%, such as about 4.5%.

In an embodiment, the thickness of the plastics foam element in the momentum direction is less than 6 mm, such as less than 5 mm, such as less than 3 mm.

In an embodiment, the impact arrangement forms a blocking stop, such as an end stop, for the movement element, such that the movement element is a manually adjustable or motor-adjustable lever and in that the impact arrangement provides a blocking stop for the lever, or in that the movement element is a manually adjustable or motor-adjustable pawl and in that the impact arrangement provides a blocking stop for the pawl, or in that the movement element is a motor-adjustable actuator and in that the impact arrangement provides a blocking stop for the actuator, such that the actuator is a constituent part of a central locking drive for the motor vehicle lock.

In an embodiment, the movement element is a lock striker assigned to the motor vehicle lock and in that the impact arrangement provides a damping receptacle for the lock striker, such that the impact arrangement is arranged in an inlet opening, assigned to the lock striker, of the motor vehicle lock.

In an embodiment, the plastics foam element is fastened, such as adhesively bonded, clamped or the like, to a receptacle surface.

In an embodiment, the plastics foam element is received at least partially in a form-fitting manner such as a pocket-like formation, and/or in that the plastics foam element is otherwise fastened to the locking system component by way of its inherent elasticity, and/or in that the plastics foam element is configured substantially in a sleeve-like manner and is pushed over a mandrel-like receptacle, such that the plastics foam element is pushed onto the receptacle under prestress, elastically widening the plastics foam element.

### BRIEF DESCRIPTION OF THE FIGURES

The invention is explained in more detail in the following text with reference to a drawing that illustrates merely exemplary embodiments. In the drawing:

FIG. 1 shows a locking system according to the proposal, having a motor vehicle lock according to the proposal,

FIG. 2 shows a central locking drive of the motor vehicle lock according to FIG. 1,

FIG. 3 shows the components lock latch, pawl and opening drive of the motor vehicle lock according to FIG. 1,

FIG. 4 shows the inlet opening of the motor vehicle lock according to FIG. 1.

The drawing illustrates only those parts of a motor vehicle lock which are significant for the invention.

### DETAILED DESCRIPTION

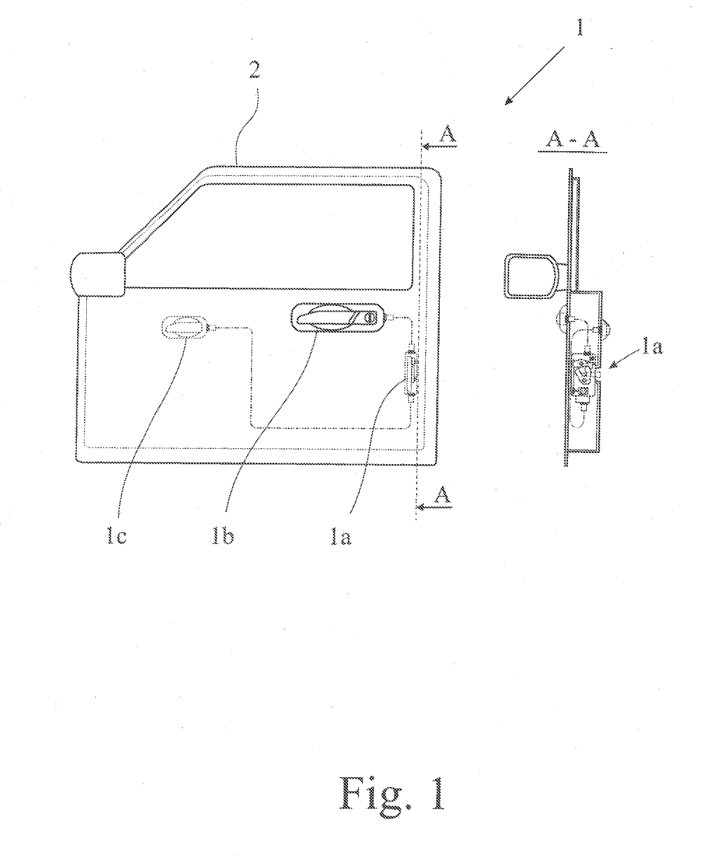

FIG. 1 shows a locking system 1 which has a locking system component 1a configured as a motor vehicle lock, a locking system component 1b configured as an outside door handle, and a locking system component 1c configured as an inside door handle. The following text deals primarily with the motor vehicle lock 1a, although this should not be understood in a limiting manner. All the embodiments for the motor vehicle lock 1a are applicable in a corresponding manner for all other types of locking system components.

The locking system 1 is assigned here to a closure element 2 configured as a side door. With regard to the broad expression “closure element”, reference may be made to the statements in the introductory part of the description. All statements made with respect to a side door 2 are applicable in a corresponding manner for all conceivable closure element variants.

The motor vehicle lock 1a has an impact arrangement 3 which serves to absorb momentum of a movement element 4 to be explained below. In this case, the motor vehicle lock 1a is equipped with three different movement elements 4a, 4b, 4c, each of which is assigned an impact arrangement 3a, 3b, 3c.

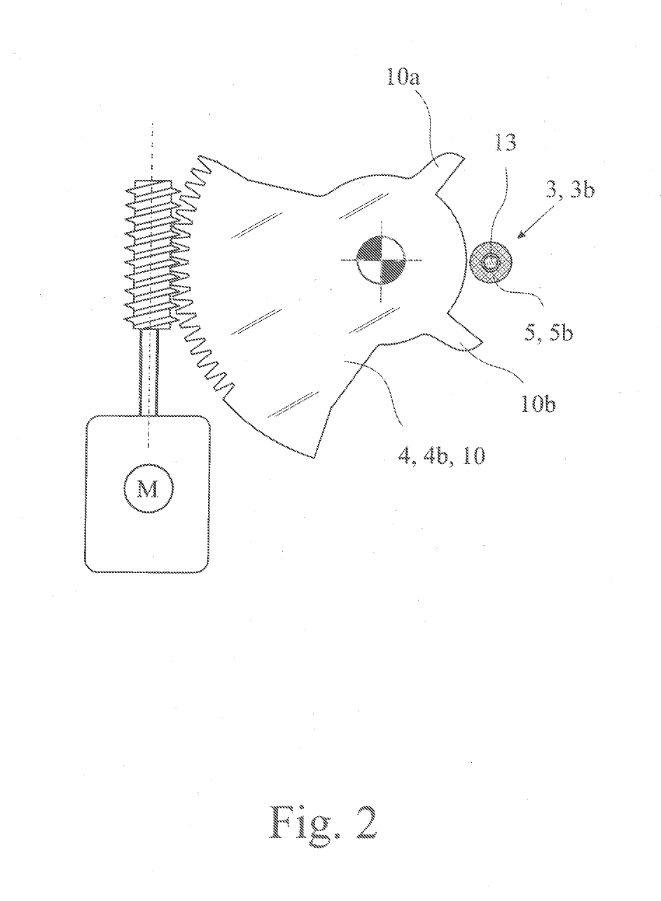

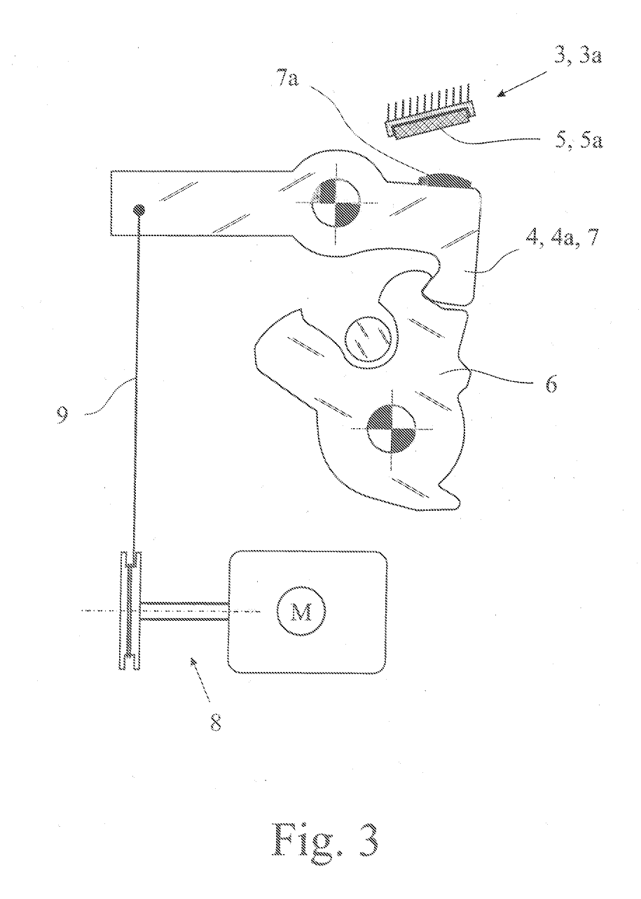

In FIGS. 2 and 3, the movement elements 4a, 4b are mounted in a movable manner in the motor vehicle lock 1a. In FIG. 3, the movement element 4c is movable independently of the motor vehicle lock 1a.

What is essential for the teaching according to the proposal is that the impact arrangement 3 has a plastics foam element 5 which consists at least partially, such as completely, of a microcellular, open-cell plastics foam, in particular a polyurethane foam. The advantages associated therewith, in particular with respect to the damping properties that can be achieved, were explained above.

As already mentioned, the locking system component discussed primarily here is the motor vehicle lock 1a, which can be brought into engagement in a conventional manner with a lock striker 12 or the like.

In an embodiment, a locking system component is configured in the above sense as an auxiliary locking arrangement, by way of which adjustment of the closure element 2 from a pre-locking position into a main locking position is able to be brought about. Other variants for the locking system component are conceivable.

Numerous possibilities for the structural implementation of the impact arrangement 3 are conceivable. For example, provision may be made for the plastics foam element 5 of the impact arrangement 3 to be brought into direct engagement with the respective movement element 4 when the momentum is absorbed. This can be seen in all of the illustrated exemplary embodiments in the fact that the respective plastics foam element 5 is always arranged in a manner open towards the movement element 4 and not for instance in an encapsulated manner.

However, it is also in principle conceivable for the impact arrangement 3 to provide a separate contact surface between the plastics foam element 5 and the movement element 4, said separate contact surface being able to be brought into direct engagement with the movement element 4 when the momentum is absorbed and directing the momentum onto the plastics foam element 5.

It may also be noted that the plastics foam element 5, as illustrated, may be configured in one piece, this resulting in a cost-effective variant. Alternatively, the plastics foam element 5 may be configured in more than one piece, in particular from a plurality of layers of plastics foam elements. With the last-mentioned variant, the impact behaviour can be set in a particularly precise manner by way of a suitable choice of the individual layers.

Particularly positive experiences have been gained with the solution according to the proposal when the plastics foam element material has been configured as PORON® material. This is applicable, as mentioned above, in particular for the damping behaviour which can be achieved. The PORON® material 4790-92 (Rogers Corporation product designation) can be used. Also the PORON® materials 4701-30, 4701-40 and 4701-41 can be used.

The cell size of the cells of a plastics foam element material can be between about 3 μm and about 500 μm, such as between about 10 μm and about 70 μm, such as about 40 μm.

Furthermore, a plastics foam, the density of which, measured according to ASTDM D 3574-95 Test A, is in a range between about 200 kg/m³ and 440 kg/m³, has proven successful for the application with the solution according to the proposal.

In this case, the hardness (Shore “O”) of the plastics foam, measured by durometer according to ASTM D 2240-97, can be between about 1.5 and about 70, such as between about 1.5 and about 4, such as about 2.

The damping behaviour is reflected best by the determination of what is known as recovery, measured using a resiliometer according to ASTM D 2632 (vertical rebound). This is also known as “resilience by vertical rebound”. The recovery measured in this way can be between about 3% and about 9%, such as between about 4% and about 8% and such as about 4.5%. These low values make it clear that, with such a design, bouncing behaviour, mentioned at the beginning, can scarcely occur.

It has already been noted that, after its deformation, the plastics foam according to the proposal relaxes relatively slowly into its starting constellation. In an embodiment, the relaxation following a deformation takes place by 50% in a time period between 0.1 s and 2 s. This is readily acceptable in the application in question.

Surprisingly, the plastics foams according to the proposal can be designed to be very thin in the momentum direction while having good damping behaviour. The thickness of the plastics foam element 5 in the momentum direction can be less than 6 mm, such as less than 5 mm, such as less than 3 mm.

The damping behaviour that is achievable with the plastics foam according to the invention can be used to its full extent when the impact arrangement 3 forms a blocking stop, in particular an end stop, for the movement element 4. This is the case in all embodiments illustrated.

For example, the movement element 4 may be a manually adjustable or motor-adjustable lever, in which case the impact arrangement 3 would then provide a blocking stop for the lever. Such a lever may be for example a central locking lever of the motor vehicle lock 1a.

In an embodiment shown in FIG. 3, the motor vehicle lock 1a is equipped with the locking elements lock latch 6 and pawl 7, and in some embodiments with an auxiliary opening drive 8 assigned to the pawl 7. In principle, it may also be a pawl 7 that can be lifted out manually. The pawl 7 forms in both cases an above-discussed movement element 4a. In this case, the auxiliary opening drive 8 is a cable drive having a drive cable 9 which is to be protected against pulse-like force effects. For this purpose, the pawl 7 is assigned the impact arrangement 3a which the pawl 7 strikes by way of a stop 7a on reaching its lifted out position. With the solution according to the proposal, it is possible, as mentioned, to prevent bouncing back, this being associated with corresponding protection of the drive cable 9.

FIG. 2 shows an arrangement having a motor-adjustable actuator 10 which likewise provides a movement element 4b in the above sense. The actuator 10 is assigned an impact arrangement 3b which in turn provides a blocking stop, in this case a blocking stop on both sides, for the actuator 10. For this purpose, the actuator 10 is equipped with two stop surfaces 10a, 10b. Here, on account of the elimination of bouncing back, precise positionability in the blocking mode is particularly advantageous. The actuator 10 may be for example a constituent part of the central locking drive for the motor vehicle lock 1a.

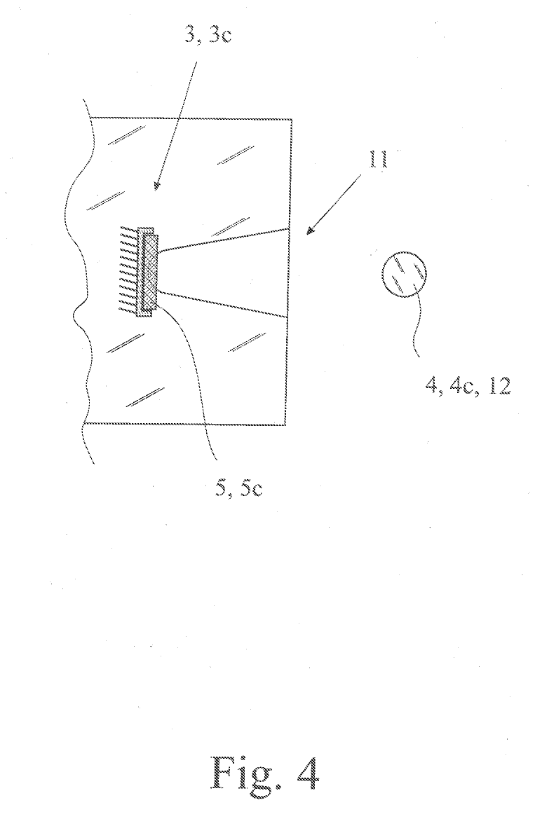

FIG. 4 shows the inlet opening 11 of the motor vehicle lock. The inlet opening 11 serves for the inlet of a lock striker 12 which can be brought into engagement with the above-discussed lock latch 6. The lock striker 12 is usually arranged in a manner fixed to the body and only comes into engagement with the motor vehicle lock 1a, in particular with the lock latch 6, when the closure element 2 is closed. What is interesting in the exemplary embodiment shown in FIG. 4 is the fact that the lock striker 12 is a movement element 4c in the above sense. The lock striker 12 is assigned an impact arrangement 3c which is located at one end of the inlet opening 11. The impact arrangement 3c provides a damping receptacle for the lock striker 12 when the lock striker 12 has passed through the inlet opening 11.

The fastening of the plastics foam element 5 such that mounting is easy and operational reliability is high is of particular significance in the present case. In an embodiment, the fastening comprises adhesive bonding. Another variant is based on clamping the plastics foam element 5. The plastics foam element can also advantageously be received at least partially in a form-fitting manner in an in particular pocket-like formation.

A variant in which the plastics foam element 5 is otherwise fastened to the locking system component 1a by its inherent elasticity is particularly cost-effective and simultaneously robust. In the embodiment which is illustrated in FIG. 2, the plastics foam element 5b is configured substantially in a sleeve-like manner and is pushed over an in particular mandrel-like receptacle 13. It is particularly advantageous for fastening if the plastics foam element 5 is pushed onto the receptacle 13 under prestress, elastically widening the plastics foam element 5.

Different variants are also possible for the production of the plastics foam element 5. In one variant, the plastics foam element 5 is extruded. In this case, the plastics foam element 5 can be punched out of an extruded semifinished product. It is possible to dispense with punching if the plastics foam element 5 is injection-moulded in a plastics material injection-moulding process.

According to a further teaching, which has independent meaning, a locking system 1 having a motor vehicle lock 1a according to the proposal and/or having an auxiliary locking arrangement according to the proposal is claimed. Reference may be made to all statements made with respect to the motor vehicle lock 1a and auxiliary locking arrangement.

We claim:

1. A locking system component for a locking system which is assigned to a closure element of a motor vehicle, wherein an impact arrangement for absorbing momentum of a movement element is provided,
wherein the impact arrangement has a plastics foam element which consists at least partially, of a microcellular, open-cell plastics foam.

2. The locking system component according to claim 1, wherein the locking system component is configured as a motor vehicle lock.

3. The locking system component according to claim 1, wherein the locking system component is configured as an auxiliary locking arrangement, by way of which adjustment of the closure element from a pre-locking position into a main locking position is able to be brought about.

4. The locking system component according to claim 1, wherein the plastics foam element of the impact arrangement can be brought into direct engagement with the movement element when the momentum is absorbed, or in that the impact arrangement provides a separate contact surface between the plastics foam element and the movement element, said separate contact surface being able to be brought into direct engagement with the movement element when the momentum is absorbed and directing the momentum onto the plastics foam element.

5. The locking system component according to claim 1, wherein the plastics foam element material is configured as PORON® material.

6. The locking system component according to claim 1, wherein the cell size of the cells of the plastics foam element material is between about 3 μm and about 500 μm.

7. The locking system component according to claim 1, wherein the density of the plastics foam element material, measured according to ASTDM D 3574-95 Test A, is in a range between about 200 kg/m³ and 440 kg/m³.

8. The locking system component according to claim 1, wherein the hardness (Shore “O”), measured by durometer according to ASTM D 2240-97, is between about 1.5 and about 70.

9. The locking system component according to claim 1, wherein the recovery, measured using a resiliometer according to ASTM D 2632 (vertical rebound), is between about 3% and about 9%.

10. The locking system component according claim 1, wherein the thickness of the plastics foam element in the momentum direction is less than 6 mm.

11. The locking system component according to claim 1, wherein the impact arrangement forms a blocking stop for the movement element.

12. The locking system component according to claim 1, wherein the movement element is a lock striker assigned to the motor vehicle lock and in that the impact arrangement provides a damping receptacle for the lock striker.

13. The locking system component according to claim 1, wherein the plastics foam element is fastened, clamped or the like, to a receptacle surface.

14. The locking system component according to claim 1, wherein the plastics foam element is received at least partially in a form-fitting manner, and/or in that the plastics foam element is otherwise fastened to the locking system component by way of its inherent elasticity, and/or in that the plastics foam element is configured substantially in a sleeve-like manner and is pushed over a receptacle.

15. The locking system component according to claim 1, wherein the microcellular, open-cell plastic foam comprises polyurethane foam.

16. The locking system component according to claim 1, wherein the plastics foam element consists completely of a microcellular, open-cell plastics foam.

17. The locking system component according to claim 11, wherein the movement element is a manually adjustable or motor-adjustable lever and in that the impact arrangement provides a blocking stop for the lever, or in that the movement element is a manually adjustable or motor-adjustable pawl and in that the impact arrangement provides a blocking stop for the pawl, or in that the movement element is a motor-adjustable actuator and in that the impact arrangement provides a blocking stop for the actuator.

18. The locking system component according to claim 12, wherein the impact arrangement is arranged in an inlet opening, assigned to the lock striker, of the motor vehicle lock.

19. The locking system component according to claim 13, wherein the plastics foam element is adhesively bonded to a receptacle surface.

20. The locking system component according to claim 14, wherein the plastics foam element is pushed onto the receptacle under prestress, elastically widening the plastics foam element.
